(19) United States
(12) Patent Application Publication
(10) Pub. No.: US 2015/0024228 A1
(43) Pub. Date: Jan. 22, 2015

(54) BOARD DEWATERING SYSTEM AND METHOD

(71) Applicant: United States Gypsum Company, Chicago, IL (US)

(72) Inventors: Alfred Li, Naperville, IL (US); Ronald E. Schenck, Valparaiso, IN (US); Chris C. Lee, Mt. Prospect, IL (US)

(21) Appl. No.: 14/321,205

(22) Filed: Jul. 1, 2014

Related U.S. Application Data
(60) Provisional application No. 61/856,989, filed on Jul. 22, 2013.

(51) Int. Cl. B28B 17/02; E04C 2/34; E04C 2/04; B28B 3/00

(52) U.S. Cl. CPC B28B 17/023; B28B 3/006; E04C 2/34; E04C 2/043
USPC 428/537.7; 156/39; 156/346

(57) ABSTRACT

A cementitious product with strengthened composite structure is provided. Energy-efficient methods for manufacturing such products are provided as well and include dewatering a partially-set cementitious product by applying vacuum, and also creating a concentration gradient across the product thickness. Systems for manufacturing such products are provided as well.

### CROSS-REFERENCE TO RELATED APPLICATIONS

This application claims the benefit of priority from U.S. Provisional Patent Application 61/856,989 filed Jul. 22, 2013, the entire disclosure of which is incorporated herein by reference.

### FIELD OF THE INVENTION

The present disclosure relates to board manufacturing and, more particularly, to continuous board manufacturing systems and methods.

### BACKGROUND OF THE INVENTION

It is well-known to produce gypsum board by uniformly dispersing calcined gypsum (commonly referred to as “stucco”) in water to form an aqueous calcined gypsum slurry. The aqueous calcined gypsum slurry is typically produced in a continuous manner by inserting stucco, water and other additives into a mixer. The mixer includes means for agitating the contents to form a uniform gypsum slurry. In certain applications, the slurry is continuously directed toward and through a discharge outlet of the mixer and into a discharge conduit connected to the discharge outlet of the mixer. An aqueous foam can be combined with the aqueous calcined gypsum slurry in the mixer and/or in the discharge conduit. The stream of slurry and aqueous foam passes through the discharge conduit from where it is continuously deposited onto a moving web of cover sheet material supported by a forming table. The slurry is allowed to spread over the advancing web. A second web of cover sheet material is applied to cover the slurry and form a sandwich structure of a continuous wallboard preform, which is subjected to forming, such as at a conventional forming station, to obtain a desired thickness. The calcined gypsum reacts with the water in the wallboard preform and sets as the wallboard preform moves down a manufacturing line. The wallboard preform is cut into segments at a point along the line where the wallboard preform has set sufficiently, the segments are flipped over, dried by application of heat, for example, in a kiln, to evaporate excess water, and processed to provide the final wallboard product of desired dimensions.

Prior devices and methods for addressing some of the operational problems associated with the production of gypsum wallboard are disclosed in commonly-assigned U.S. Pat. Nos. 5,683,635; 5,643,510; 6,494,609; 6,874,930; 7,007,914; 7,296,919; and 7,364,676, which are incorporated herein by reference.

The weight proportion of water relative to stucco that is combined to form a given amount of finished product is often referred to in the art as the “water-stucco ratio” (WSR). A reduction in the WSR without a formulation change will correspondingly increase the slurry viscosity, thereby reducing the ability of the slurry to spread on the forming table. Reducing water usage (i.e., lowering the WSR) in the gypsum board manufacturing process can yield many advantages, including the opportunity to reduce the energy demand in the process by reducing the energy required to evaporate water from the board preforms. However, spreading increasingly viscous gypsum slurries uniformly on the forming table presents a great challenge.

Furthermore, in some situations where the slurry is a multi-phase slurry including air, air-liquid slurry separation can develop in the slurry discharge conduit of the mixer. As WSR decreases, the air volume increases to maintain a relatively unchanged dry density. As WSR decreases, the degree of air phase separation from the liquid slurry phase increases, which can result in increased mass or density variation in the finished wall board.

It will be appreciated that this background description has been created by the inventors to aid the reader and is not to be taken as an indication that any of the indicated problems were themselves appreciated in the art. While the described principles can, in some aspects and embodiments, alleviate the problems inherent in other systems, it will be appreciated that the scope of the protected innovation is defined by the attached claims and not by the ability of any disclosed feature to solve any specific problem noted herein.

### SUMMARY OF THE INVENTION

This invention provides a cementitious product, such as boards, with increased strength. It also provides energy-efficient methods for manufacturing such products by dewatering and creating a concentration gradient. Systems for performing the methods are provided as well.

One embodiment of the present invention provides a method for manufacturing a cementitious product with a strengthened composite structure. In this method, a cementitious slurry is prepared with gypsum and water first, and the cementitious product is then formed by depositing the slurry between two paper layers, a face paper layer and a back paper layer. The product is then disposed over at least one device such as a scraping device or a vacuum box and vacuum is then applied to the cementitious product.

In some embodiments, the product is disposed over at least one vacuum box such that the face paper layer of the board is at least partially in contact with the at least one vacuum box. In some embodiments, the product is disposed over at least one vacuum box such that the back paper layer of the product is at least partially in contact with the at least one vacuum box. In other embodiments, the product is disposed over at least one vacuum box such that the face paper layer and the back paper layer of the product are at least partially in contact with the at least one vacuum box.

In some embodiments, the applied vacuum is sufficient to create a moisture gradient across the product thickness. In further embodiments, the applied vacuum is sufficient to drain water from the product. In further applications, the applied vacuum is maximized by adjusting a drainage velocity (u) of water through the board according to the equation 1:

$$u = \frac{1}{A} \frac{d V}{d t} = \frac{- Δ {P}_{t}}{μ [ {R}_{C} + {R}_{P 1} + {R}_{P 2} ]}$$

where A is the drainage area,
−ΔPₜ is the pressure difference,
μ is the viscosity of water,
R_{C} is a constant parameter indicative of the drainage resistance by the product core,
R_{P1} and R_{P2} are, respectively, the drainage resistance of the first paper layer and the second paper layer,
t represents time, and
V represents the volume of water (filtrate) in the product.

In some embodiments, vacuum is applied to only one side of a cementitious product, in other embodiments vacuum is applied to both sides of the product.

Further embodiments include a cementitious product comprising a gypsum core sandwiched between two paper layers, wherein at least one paper layer comprises deposits of crystallized gypsum. These deposits of crystallized gypsum have been obtained by applying vacuum to the product at any time after the product has been already formed, but before it became fully set. Various cementitious products are contemplated, including ceiling tiles, boards, wall panels and wall partitions. In some embodiments, the cementitious product is formulated such that its gypsum core comprises starch with a concentration gradient throughout the product thickness such that the starch is concentrated at the surface of the gypsum core on at least one side of the product.

Still further, this invention provides a system for manufacturing a cementitious product. The system includes a mixer for preparing a cementitious slurry with water, a forming station with a conveyor which facilitates continuous production of the cementitious product and at least one device selected from the group consisting of a vacuum device and a scraping device. At least in some embodiments, the vacuum device is a vacuum box with slots which are slanted. The scraping device may comprise a vacuum box with a board-engaging surface made up of a series of peaks defined at the tips of elongated bars having a generally trapezoid cross sectional shape. Further embodiments for the system may include a set of means generating and applying heat to a cementitious product.

### BRIEF DESCRIPTION OF THE DRAWINGS

FIG. 1 illustrates a cross section of a wall board subjected to vacuum in accordance with the disclosure.

FIG. 2 illustrates a side view of a board forming system in accordance with the disclosure.

FIG. 3 illustrates a top view of a board forming system in accordance with the disclosure.

FIG. 4 illustrates a side view of an entrance to a board drying system in accordance with the disclosure.

FIGS. 5-8 illustrate different embodiments for vacuum box configurations in accordance with the disclosure.

FIG. 9 illustrates a side view of the FIG. 8 embodiment for a board interface configuration in accordance with the disclosure.

### DETAILED DESCRIPTION OF THE INVENTION

The disclosure relates to continuous manufacturing methods for boards and, more specifically, to systems and methods for use in dewatering a cementitious slurry used to form the boards, after the boards are substantially formed, but before the slurry has fully set. By removing excess water from the boards, i.e., water within a core of the board that is not used to set the cementitious slurry, the cost and time required to produce a finished board can be reduced.

In the disclosed systems and methods, water removal from unfinished boards is removed actively, for example, by application of a vacuum on one or both sides of the finished boards, and/or passively, by scraping or siphoning water that migrates onto the surface of the board. These active and passive water removal modes can he used together or separately in a board manufacturing process as described herein.

When removing water from a board, the systems and methods disclosed herein may use a pressure differential and/or gravity to help liquid water and vapor to migrate to the surface of the board for physical removal of the water in the liquid or vapor phase. It has been determined that such water migration for removal, while advantageous in shortening the drying time for the boards, also aids in strengthening the composite structure of the board by virtue of the soluble gypsum that is carried with the water to the surface of the board deposited onto the paper layers. Specifically, soluble gypsum can be carried from core portions of the board onto the surface thereof. Along with the soluble gypsum, certain starch particles present the slurry that forms the board may also migrate to the surface and collect at or along an interface between the cementitious layer and paper layers of the board. Crystallization of the soluble gypsum within the paper acts to strengthen the paper and thus the composite board structure. This strengthening effect is augmented by better adhesion of the paper layers to the core cementitious structure of the board owing to the collection of starch that migrated at the interface there between as a result of the water migration. These and other characteristics of the board dewatering techniques, as well as board forming structures and methods, will now be described.

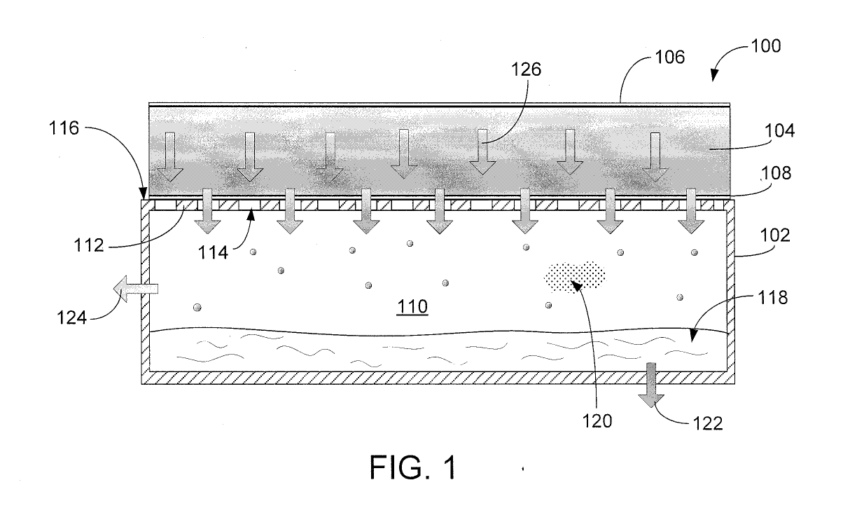

A cross section of a board segment 100 during manufacture, shown disposed over a vacuum device or, in one embodiment, a vacuum box 102 as shown in FIG. 1 for illustration. The board segment 100 may be a segment of a continuous board shortly after formation of the board by deposition of a cementitious layer 104, typically applied in slurry form, between first and second paper layers 106 and 108. In the illustration of FIG. 1, the first paper layer 106 may be a back paper layer, and the second paper layer 108 may be a face paper layer, but these layers can be reversed for application of vacuum. Further, even though a single vacuum box 102 disposed on one side of the board 100 is shown, an additional box or other source of vacuum can be synchronously applied to the other side of the board.

The vacuum box 102 in the illustrated embodiment includes an enclosed space 110 having an interface plate 112 on one side onto which the board 100 contacts. The interface plate 112 may have openings 114 formed therein that fluidly connect the enclosed space with a board interface surface 116 that slidably engages the board 100 as the board travels along a manufacturing line. During operation, a vacuum is applied to the enclosed space 110. As the enclosed space 110 is subjected to a reduced pressure, Pᵥ, the board 100 is pressed against the board interface surface 116 by action of higher, ambient pressure, Pₐ, such that a pressure differential, Pₜ, defined as Pₜ=Pₐ−Pᵥ, is created across the thickness of the board 100. It should be noted that the vacuum selected is sufficient to draw water from the board and into the vacuum box, as will be described below, but is also low enough so as not increase friction between the board 100 and the board interface surface 116 enough to impede motion of the board along the manufacturing line or to deform the board by drawing the still-unset slurry through the openings 114. The maximization of vacuum for different types of boards, slurries and extents of slurry setting can be determined empirically. In the illustrated embodiment, a vacuum of about 10-20 in. Hg. (about 25-50 mm Hg) was applied.

Under action of the vacuum, a drainage velocity, u, of water through the board 100 can be estimated. One possible estimation method is based on an equation in accordance with Darcy's law, which is provided in Equation 1, below.

$$u = \frac{1}{A} \frac{d V}{d t} = \frac{- Δ {P}_{t}}{μ [ {R}_{C} + {R}_{P 1} + {R}_{P 2} ]}$$

where A is the drainage area, i.e, the area of the board 100 that is subjected to vacuum, −ΔPₜ is the pressure difference or, stated differently, the total pressure drop across the composite board structure including the first paper layer 106, the core 104, and the second paper layer 108 of the board 100, μ is the viscosity of water, R_{C} is a constant parameter indicative of the drainage resistance by the core, which can be experimentally determined for a given core thickness, degree of set, and composition, R_{P1} and R_{P2} are, respectively, the drainage resistance of the first paper layer 106 and the second paper layer 108, each of which can be experimentally determined for the particular paper type used to form the board 100, t represents time, and V represents the volume of water (filtrate) in the board. It should be appreciated that for other board types, for example, ceiling tiles, which are not typically composite structures, an overall drainage resistance of the board can be determined and used in Equation 1. Moreover, Equation 1 can also be used when vacuum is applied to both sides of the board, in which instance the drainage area can be adjusted to reflect the increased area of the board subjected to vacuum.

During operation, water is removed from the board 100 by action of the vacuum. In the illustration of FIG. 1, liquid water 118 in the form of drops can be collected, as well as vapor 120 can be extracted due to the lower-than-atmospheric pressure present within the enclosed space 110 by evaporation of water from the board surface. The liquid water 118 can be drawn out of the vacuum box 102 and reused in slurry-making operations. The vapor 120 can be withdrawn from the enclosed space 110 along with air evacuated there from, transformed to a liquid state in a condenser (not shown), and also used in slurry-making or other operations. Accordingly, a liquid removal port 122 is fluidly communicating with the enclosed space 110, and a vapor and air removal port 124, which may be connected to a pump (not shown), can also be fluidly in communication with the enclosed space 110. Arrows 126 are used to denote the migration direction of liquid water and vapor from within the core 104 to the surface of the board and then to the enclosed space 110.

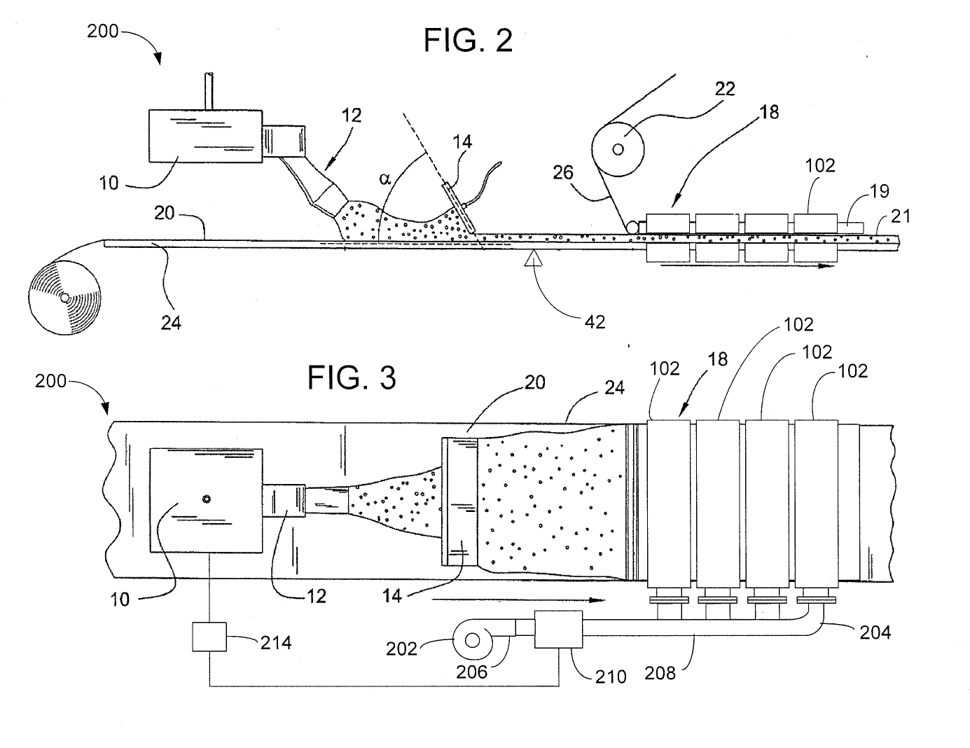

A board forming system 200 in accordance with the disclosure is shown from a side perspective in FIG. 2 and from a top perspective in FIG. 3. The board forming system 200 includes a mixer 10 with a discharge outlet 12. In the illustrated embodiment, a slurry spreader 14 is optionally used. The board forming system 200 further includes a forming station 18, a backing layer 20, an optional cover layer roll 22, and a forming table with a conveyor 24 to facilitate the continuous production of cementitious board product. In operation, cementitious slurry used for forming the core of the board is prepared in mixer 10 and discharged through discharge outlet 12 directly or indirectly onto backing layer 20. The discharge outlet (or depositing mechanism) can be any suitable discharge outlet. For example, suitable slurry discharge outlets are described in U.S. Pat. No. 6,874,930, which is incorporated by reference herein. The slurry from the mixer can be deposited directly onto the face paper, although in some embodiments, the slurry from the mixer is deposited indirectly onto the face layer, such as for example, onto a densified layer.

In one embodiment, such as for gypsum wallboard or acoustical panel production, including but not limited to ceiling tile, wall panel, and partitions for office cubicles, the slurry for forming the core of the board is deposited onto a densified layer (i.e., a skim coat layer) of cementitious slurry carried by the face layer, as described, for example, in U.S. Pat. Nos. 4,327,146 and 5,718,797, each of which is incorporated by reference herein. As is known in the art, the densified layer can be achieved by directing a portion of the slurry out of the mixer prior to introduction of foam or by beating foam out of the slurry. As is also known in the art, a second densified layer can optionally be applied on top of the core slurry, particularly in embodiments where a cover layer is employed such as with gypsum drywall. The densified layer(s) can have any suitable thickness, such as, for example, from about 0.0625″ to about 0.125″ (between about 1.6 to 3.2 mm).

Backing layer 20 is discharged onto conveyor 24 and is carried by the conveyor, preferably continuously, to facilitate the continuous formation of cementitious board. In conventional manufacture of cementitious board, the backing layer typically is paper, for example manila paper or kraft paper, non-woven glass scrims, woven glass mats, other synthetic fiber mats such as polyester, metallic foil such as aluminum, and the like, and combinations thereof. In some embodiments, such as in Portland cement board production, backing layer 20 is a release layer that is removable from the board product. The backing layer with slurry deposited thereon is optionally covered with a cover layer 26 discharged from cover layer roll 22. The wet board then passes through forming station 18 that includes a forming platen 19. The distance between the forming table 20 and forming platen 19 can determine the thickness of the board being produced. Slurry spreader 14 is positioned such that at least a portion of the cementitious slurry contacts the slurry spreader after the slurry exits discharge outlet 12 and before the slurry passes through forming station 18, as backing layer 20 travels in the direction of the forming station.

At the forming station, wet board precursor is sized to a pre-determined width and thickness, and optionally, length. In the illustrated embodiment, the forming station is further configured to remove water from the wet board, which can shorten board preform drying time and reduce the energy required for drying the board preforms later in the manufacturing process. Water can be removed from the wet board using mechanical means such as the application of vacuum, use of hydrophilic absorptive materials, or other liquid and water vapor collection methods.

In the illustrated embodiment, the forming table 20 and forming platen 19 are water-permeable along portions thereof along which dewatering operations are performed. Vacuum boxes 102 are arranged along the forming station 18 at both the top and bottom surfaces of the board perform 21. Each of the vacuum boxes 102 operates in substantially the same way as previously described relative to FIG. 1 to remove liquid water and vapor from the board perform 21. Four vacuum boxes 102 are shown on either side of the perform 21, for a total of eight boxes, but it should be appreciated that any number of boxes disposed on one or both sides of the preform may be used.

In the board forming system 200, vacuum is provided to the respective enclosed spaces 110 (FIG. 1) of the vacuum boxes 102 by a vacuum pump 202, which can be any appropriate type of pneumatic pump. Conduits 204 fluidly connect a working port 206 of the pump 202 with each of the eight vacuum boxes 102 (only the four top connections are visible in FIG. 3). In this way, liquid water and vapor collected in the vacuum boxes 102 can be collected within a collector conduit 208 from all vacuum boxes 102. The water thus collected, which shares the collector conduit 208 with air removed from the vacuum boxes 102, passes through a water removal device 210 before reaching the pump 202. The water removal device 210 may include a trap for collecting liquid water as well as a condenser for separating water vapor from the air passing there through. Collected liquid water and condensate can be removed from the water removal device 210 by a return conduit 212 that includes a pump or other metering device 214 and provided back to the mixer 10 for reuse in making slurry. In this way, any soluble compounds that may have been carried by the liquid water removed from the board perform 21 can advantageously be collected and reused.

In addition to the water removal function, the forming station includes, or can be, any device capable of performing a final mechanical spreading and/or shaping of the slurry across the width of the backing layer, many of which are known in the art. The forming station comprises structures for conforming the slurry thickness and width to the final desired thickness and width of a wet board precursor that, when set, will produce the cementitious board product. The final desired slurry thickness and width produced at the forming station can, of course, differ from the final thickness and width of the finished board product. For example, the slurry thickness and/or width can expand and/or contract during crystallization (i.e., setting), dewatering operation, and drying of the slurry. In the illustrated embodiment, the forming station is configured to adjust the thickness of the cementitious board product appropriately to account for the water removed. Typically, the desired slurry thickness is substantially equal to the desired board thickness (e.g., about 0.375″, about 0.5″, about 0.625″, about 0.75″, about 1″, or thicker). By way of illustration only, the final board thickness typically is within about ±⅛″ or less of the final slurry thickness.

The forming station includes any device that is capable of creating the desired slurry thickness and width of the wet board precursor. Suitable devices include, for example, a forming plate, a forming roller, a forming press, a screed, and the like. The vacuum boxes 102 can be connected to or, alternatively, integrated with, any of these structures. The particular device used will depend, in part, on the type of cementitious board being produced. In a preferred embodiment, for example when the board forming system is a gypsum board or acoustical panel forming system, the board forming station comprises the forming platen 19 as is known in the art (see FIG. 2). In other embodiments, for example when the board forming system is a Portland cement board forming system, the forming station is a forming roller or screed. In such case, the vacuum boxes 102 may be arranged around a periphery of the roller, or on a backside of the screed, such that the board preform can be effectively subjected to vacuum as it passes through the forming station. The board forming system of any of the above embodiments optionally further comprises a vibrator capable of vibrating the slurry disposed on the face layer, a blade for cutting wet board precursor or dry cementitious board product to the desired lengths, and/or an evaporative drying region that uses heat to remove additional water from the set cementitious board.

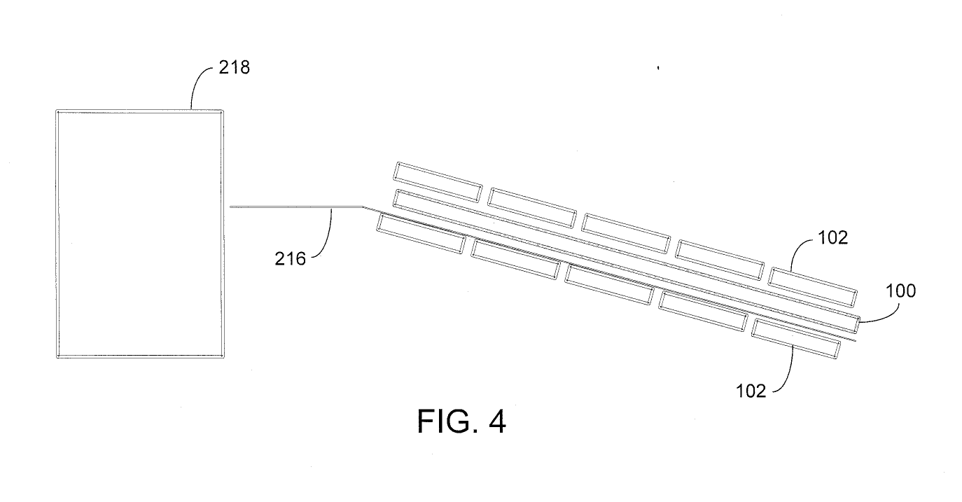

One example of an additional vacuum box configuration for a board manufacturing system is shown in FIG. 4. In this embodiment, two arrays of vacuum boxes 102 are arranged above and below a cut, partially-set board 100 that is carried on a conveyor 216 in a direction denoted by arrow towards a drying kiln 218, which is shown schematically. As is known, kiln-drying of wet cementitious board may be carried out to remove excess water from boards. Excess water, as used herein, is meant to encompass that water content added to the board by deposition of the cementitious slurry that is not required to set the cementitious material used in the slurry. Kilns used for this purpose may use varied speeds and temperature zones therewithin to gradually heat the boards and thus evaporate the excess water. In the illustrated embodiment, the board 100 may have already been subjected to a vacuum application to remove water, such as the in the process shown in FIGS. 2 and 3, or may alternatively be aboard containing most of the excess water or moisture present in the slurry upon board formation. In either instance, water removed from the board 100 by action of the vacuum applied via vacuum boxes 102, which may be present on one or both sides of the board as shown in FIG. 4, can advantageously remove water therefrom such that the kiln-drying process can be shortened, improved and/or otherwise optimized.

In addition to, or instead of, removing water from the boards, the vacuum box 102 configuration shown in FIG. 4 can be placed anywhere along the board manufacturing line to help create a moisture gradient along a thickness direction with respect to the board. Specifically, the application of vacuum on a board surface will operate to draw water and/or moisture towards that board surface such that a moisture gradient is created whereby more moisture is disposed closer to the surface of the board than deeper in the core of the board. With this moisture gradient, drying the board by moisture evaporation through external heat application to the board can be facilitated by reducing the time and energy required to evaporate a desired board moisture content. Moreover, a larger moisture concentration of moisture at the outer surface portions of the board can help avoid over-drying of those board portions during a drying operation.

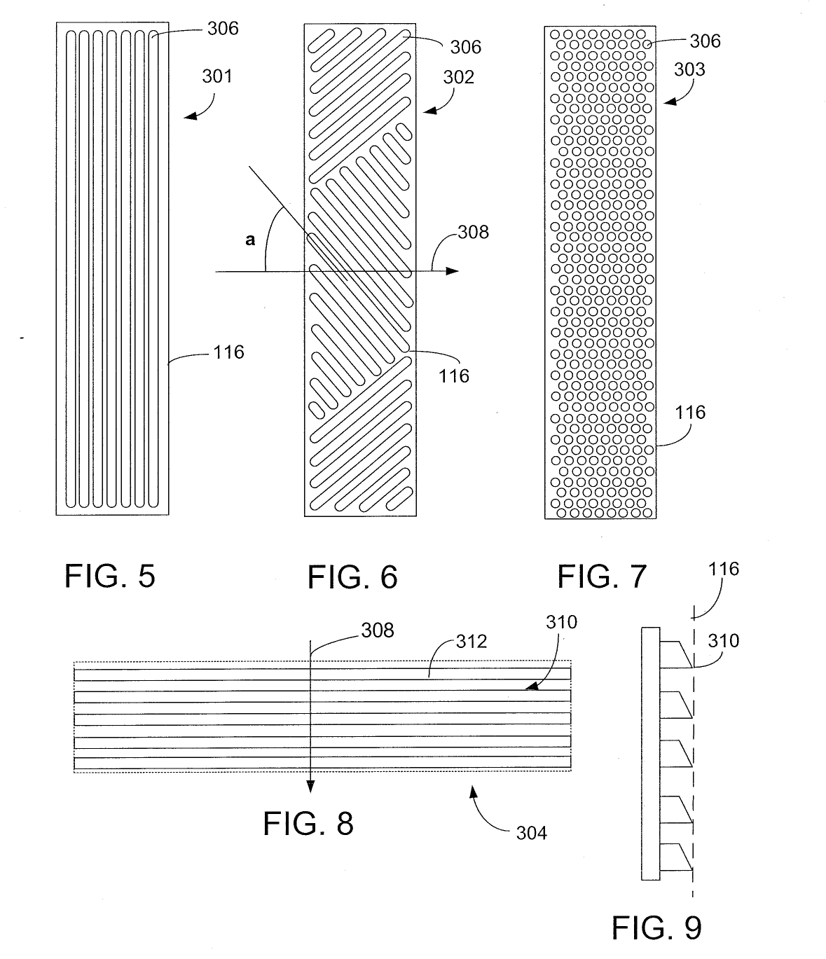

Regarding the configuration of the openings in the board-engaging surface 116 of the vacuum boxes 102, various embodiments can be used that can effectively apply vacuum to the moving board in the manufacturing process as shown, for example, in FIGS. 2 and 3, remove water and vapor from the board, and do so uniformly and without adding substantial friction opposing the motion of the board. Four exemplary embodiments for vacuum boxes 301, 302, 303 and 304 are shown, respectively, in FIGS. 5, 6, 7 and 8. In each of vacuum boxes 301, 302 and 303, the board-engaging surface is a flat surface forming openings 306.

In the vacuum box 301, the openings 306 are embodied as slots extending parallel to one another along a major box dimension such that the board (for example, board 100 as shown in FIG. 1) travels over the box 301 in a direction perpendicular to the slots 306. In the vacuum box 302, the openings 306 are embodied as slots that form an angle, α (or, as shown, 90 deg. plus or minus α), with respect to a board-travelling direction 308, which is denoted by an arrow. The difference between the vacuum boxes 301 and 302 is that, by slanting the slots 306 in vacuum box 302, no board cross section may be unsupported at it passes over a slot 306. Such support consideration may even be carried into the third alternative design of a vacuum box 303, as shown in FIG. 7. Here, the openings 306 are embodied as holes rather than as slots. The openings 306 in vacuum box 303 are tightly arranged, for example, in a close-packed hexagonal configuration, to maximize both opening space and board support. It is noted that various other slot shape can be used, for example, curved, V-shaped, and the like.

As shown in FIG. 8 and also in FIG. 9 which is a side view of the FIG. 8 embodiment, the vacuum box 304 presents yet another alternative embodiment having a different function. In this embodiment, the board-engaging surface 116 is made up of a series of peaks 310 defined at the tips of elongated bars 312 having a generally trapezoidal cross sectional shape as shown in FIG. 9. Bars 312 are arranged parallel to one another in a transverse direction relative to the board-travelling direction 308 such that lines of contact are formed between the bars 312 and the boards along the peaks 310. Vacuum may still be applied between the bars 312 to remove water and vapor from the board, but the line contact between the board and the vacuum box 304 along the peaks 310 provides an additional scraping function that can remove additional water saturating the paper layer of the board, for example, the second paper layer 108 of board 100 as shown in FIG. 1.

In use, the bars 312 may be arranged in a slanted or in any other configuration with respect to the board-travelling direction 308. Moreover, vacuum boxes of different configurations may be used together in arrays treating the same boards. For example, boxes maximizing board support such as box 303 (FIG. 7) may be used when the boards are first formed and the slurry is still un-set, while boxes or combinations of boxes such as box 301 and box 304 may be used later in the manufacturing line when the boards have partly set, thus having increased structural rigidity, and also after sufficient time has passed for the paper layers to have become saturated with water.

In one advantageous aspect, it was determined that the vacuum application and concomitant water migration out of the cementitious core of formed boards did not adversely affect void distribution within the core, which is especially important in light-weight boards such as those incorporating voids created by foams mixed with the slurry prior to deposition. For example, in boards using a slurry formulated to include water, stucco, foaming agent (sometimes referred to simply as “foam”), and other additives as desired, the resultant desirable voids in the board after setting can remain undisturbed after one or more applications of vacuum to remove excess water. In such boards, the stucco used in the board forming slurry can be in the form of calcium sulfate alpha hemihydrate, calcium sulfate beta hemihydrate, and/or calcium sulfate anhydrite. The stucco can be fibrous or non-fibrous. Foaming agent can be included to form an air void distribution within the continuous crystalline matrix of set gypsum.

In some embodiments, the foaming agent comprises a major weight portion of unstable component, and a minor weight portion of stable component (e.g., where unstable and blend of stable/unstable are combined). The weight ratio of unstable component to stable component is effective to form an air void distribution within the set gypsum core. See, e.g., U.S. Pat. Nos. 5,643,510; 6,342,284; and 6,632,550. It has been found that suitable void distribution and wall thickness (independently) can be effective to enhance strength, especially in lower density board below about 35 pcf). See, e.g., US 2007/0048490 and US 2008/0090068. Evaporative water voids, generally having voids of about 5 μm or less in diameter, also contribute to the total void distribution along with the aforementioned air (foam) voids. In some embodiments, the volume ratio of voids with a pore size greater than about 5 microns to the voids with a pore size of about 5 microns or less, is from about 0.5:1 to about 9:1. In some embodiments, the foaming agent is present in the slurry, e.g., in an amount of less than about 0.5% by weight of the stucco.

In this way, boards having relatively low densities can be manufactured with less expense and time as was previously possible. Low density boards, as used herein, include boards of various weights as a function of board thickness. For example, board density can be about 40 pounds per cubic foot or less. Additionally, suitable paper for use in forming the boards can have relatively low weight, for example, less than 45 lbs/MSF (e.g., about 33 lbs/MSF to 45 lbs/MSF) or heavier basis weights can be used when, for example, enhances nail pull resistance or enhance handling are desired. In some embodiments, to enhance strength (e.g., nail pull strength), especially for lower density board, one or both of the cover sheets can be formed from paper and have a basis weight of, for example, from about 45 lbs/MSF to about 65 lbs/MSF. If desired, in some embodiments, one cover sheet (e.g., the “face” paper side when installed) can have aforementioned higher basis weight, e.g., to enhance nail pull resistance and handling, while the other cover sheet (e.g., the “back” sheet when the board is installed) can have somewhat lower weight basis if desired.

In one exemplary application, slurry samples were tested for water removal using different paper weights. In each of a series of experiments, the slurry was prepared at a water to stucco ratio (WSR) of about 1. Southard CKS stucco was used for all experiments and the initial water used to mix the stucco sample was 150 g. To carry out the experiment, the stucco sample was placed in a Buchner funnel above a layer of paper. In a beaker sealably disposed below the funnel, the desired vacuum was applied and the water migrating out of the slurry was collected and measured.

The results of these experiments are tabulated in Table 1 below. In Table 1, the first column lists the type of paper used in each of five experiments. The porosity of each paper sample used in each experiment was empirically determined and is expressed as the number of seconds it takes for 100 cc of air to flow through each paper sample. Each experiment also included retarder in the slurry. The fourth column lists the vacuum applied in each sample, and the last column lists the amount of water removed from the slurry after 4 minutes of vacuum application.

TABLE 1

| | | | | Water Removed |
|---|---|---|---|---|
| Amount of Water | Porosity | Retarder | Vacuum | After 4 Minutes |
| Removed Paper | (sec/100 cc) | (g) | (″ Hg) | (g) |
| Filter Paper | 0 (or too low | 1 | 10 | 53.7 |
| | to be | | | |
| | measured) | | | |
| Manila - 1 | 69 | 1 | 10 | 41.1 |
| Manila - 2 | 89 | 1 | 10 | 38.4 |
| Manila - 3 | 89 | 1 | 19 | 55.4 |
| Manila - 4 | 89 | 0 | 19 | 40.0 |

Given that 150 total grams of water were present in each slurry sample, after 4 minutes of vacuum application, depending on the type of paper and amount of vacuum used, anywhere between about 26% and 37% of the water was removed from the slurry. In a manufacturing setting, it is estimated that water removal can range between 10-20% of the available water for removal. When mixing a slurry at a WSR ratio of about 1, it is estimated that about 80% of the water added to the slurry is not required for setting of the stucco or other cementitious material, and a portion of that excess water is available for removal by application of vacuum or siphoning, as discussed herein.

In applications where no paper facing is used, it is contemplated that vacuum application can be carried out either through a temporary facing material used to form the boards, and/or through a skin of already set slurry has been formed on the board.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for manufacturing a cementitious product with strengthened composite structure, the method comprising:
preparing a cementitious slurry comprising gypsum and water;
forming a cementitious product by depositing the slurry between two paper layers, a face paper layer and a back paper layer;
disposing the product over at least one device selected from the group consisting of a scraping device and vacuum box; and
strengthening the composite structure of the product by applying vacuum to the product.

2. The method of claim 1, wherein the product is disposed over at least one vacuum box such that the face paper layer of the product is at least partially in contact with the at least one vacuum box.

3. The method of claim 1, wherein the product is disposed over at least one vacuum box such that the back paper layer of the product is at least partially in contact with the at least one vacuum box.

4. The method of claim 1, wherein the product is disposed over at least one vacuum box such that the face paper layer and the back paper layer of the product are at least partially in contact with the at least one vacuum box.

5. The method of claim 1, wherein the product is partially-set at the step of disposing the product over at least one vacuum box.

6. The method of claim 1, wherein the applied vacuum is sufficient to create a moisture gradient across the product thickness.

7. The method of claim 1, wherein the applied vacuum is sufficient to drain water from the product.

8. The method of claim 1, wherein the vacuum is applied at 10-20 in Hg.

9. The method of claim 1, wherein the vacuum is maximized by adjusting a drainage velocity (u) of water through the product according to the equation 1:
$$u = \frac{1}{A} \frac{d V}{d t} = \frac{- Δ {P}_{t}}{μ [ {R}_{C} + {R}_{P 1} + {R}_{P 2} ]}$$
where A is the drainage area,
−ΔPₜ is the pressure difference,
μ is the viscosity of water,
R_{C} is a constant parameter indicative of the drainage resistance by the product core,
R_{P1} and R_{P2} are, respectively, the drainage resistance of the first paper layer and the second paper layer,
t represents time, and
V represents the volume of water (filtrate) in the product.

10. The method of claim 1, wherein the vacuum is applied to both sides of the product.

11. A cementitious product comprising a gypsum core sandwiched between two paper layers, wherein at least one paper layer comprises deposits of crystallized gypsum.

12. The cementitious product of claim 11, wherein the deposits of crystallized gypsum have been obtained by applying vacuum to the product at any time after the product has been already formed, but before the product became fully set.

13. The cementitious product of claim 11, wherein the gypsum core further comprises starch with a concentration gradient throughout the product thickness, and wherein the starch is concentrated at the surface of the gypsum core on at least one side on the product.

14. The cementitious product of claim 11, wherein the product is selected from the group consisting of a ceiling tile, board, wall panel, and a wall partition.

15. A cementitious product manufacturing system, the system comprising:
a mixer for preparing a cementitious slurry with water;
a forming station with a conveyor which facilitates continuous production of the cementitious product; and
at least one device selected from the group consisting of a vacuum device and a scraping device.

16. The system of claim 15, wherein the vacuum device is a vacuum box with slots.

17. The system of claim 16, wherein the slots in the vacuum box are slanted.

18. The system of claim 15, wherein the scraping device comprises a vacuum box with a board-engaging surface made up of a series of peaks defined at the tips of elongated bars having a generally trapezoid cross sectional shape.

19. The system of claim 15, wherein the system further includes a set of means for applying heat externally to the cementitious product

20. The system of claim 19, wherein the vacuum and heat can be applied simultaneously.
